(19) United States
(12) Patent Application Publication
(10) Pub. No.: US 2025/0242661 A1
(43) Pub. Date: Jul. 31, 2025

(54) VEHICLE MANAGEMENT SYSTEM

(71) Applicant: TOYOTA JIDOSHA KABUSHIKI KAISHA, Aichi-ken (JP)

(72) Inventors: Masahiro NISHIYAMA, Toyota-shi (JP); Kenji TSUKAGISHI, Toyota-shi (JP)

(21) Appl. No.: 19/035,852

(22) Filed: Jan. 24, 2025

(30) Foreign Application Priority Data
Jan. 30, 2024 (JP) 2024-011615

(51) Int. Cl. B60H 1/00

(52) U.S. Cl. CPC B60H 1/00878

(57) ABSTRACT

The vehicle management system comprises a temperature control device configured to cool and control the temperature of a target in-vehicle device that generates heat as a vehicle travels; and a management controller that controls driving of the temperature control device, wherein the management controller is configured to change a limit threshold value of a control parameter of the temperature control device in a manner to increase a cooling capability when a special mode, in which a travel performance is prioritized over a fuel consumption, is set as compared with a case where the special mode is not set.

### CROSS REFERENCE TO RELATED APPLICATION

This application claims priority to Japanese Patent Application No. 2024-011615 filed on Jan. 30, 2024, which is incorporated herein by reference in its entirety including the specification, claims, drawings, and abstract.

### TECHNICAL FIELD

This specification discloses a vehicle management system that manages a vehicle in which a special mode in which travel performance is prioritized over fuel consumption can be set.

### BACKGROUND

There is a target in-vehicle device that generates heat as the vehicle travels. For example, in the case of an electric vehicle, a traveling motor, a battery that supplies electric power to the traveling motor, and a power control unit (hereinafter, referred to as a “PCU”) that controls the output of electric power generate heat as the vehicle travels. When the temperature of the target in-vehicle device becomes excessively high, the vehicle cannot travel properly. Therefore, conventionally, a temperature control device for controlling the temperature of the target in-vehicle device has been proposed.

For example, Patent Document 1 discloses a cooling device for cooling a battery of a vehicle. In Patent Document 1, the flow path form of the refrigeration cycle circuit is switched to actively cool the target in-vehicle device at the timing when the sports traveling mode is selected assuming high-speed traveling on the circuit.

In general, a predetermined limit value is set as a control parameter (for example, the number of revolutions of the compressor) of the temperature control device. This is to prevent a decrease in life or a failure of a temperature control electric device (for example, a compressor, a radiator fan, a water pump, or the like) incorporated in the temperature control device.

Here, when the special mode such as the sports traveling mode is set, the heat generation amount of the target in-vehicle device increases. In such a case, when the limit value of the control parameter of the temperature control device is set to be the same as that in the case where the special mode is not set, the target in-vehicle device cannot be sufficiently cooled, and there is a possibility that the target in-vehicle device becomes excessively high in temperature. Then, when the temperature of the target in-vehicle device becomes excessively high, the output of the target in-vehicle device is limited, and the traveling performance is degraded.

Therefore, the present specification discloses a vehicle management system capable of appropriately cooling a target in-vehicle device when a special mode is set.

### CITATION LIST

PATENT DOCUMENT 1: JP.2020-111084.A

### SUMMARY

A vehicle management system disclosed in this specification comprises: a temperature control device configured to cool and control the temperature of a target in-vehicle device that generates heat as a vehicle travels; and a management controller that controls driving of the temperature control device, wherein the management controller is configured to change a limit threshold value of a control parameter of the temperature control device in a manner to increase a cooling capability when a special mode, in which a travel performance is prioritized over a fuel consumption, is set as compared with a case where the special mode is not set.

With this configuration, when the special mode is set, the target in-vehicle device can be rapidly cooled.

In this case, the management controller may include a storage provided inside or outside the vehicle, and the management controller may be configured to store a load amount of the temperature control device in the storage when the special mode is set.

By storing the load amount of the temperature control device in the storage, the load amount can be utilized for vehicle management afterwards.

In addition, the management controller may be configured to: estimate a lifetime of the temperature control device based on the load amount stored in the storage; and correct the limit threshold value of the control parameter of the temperature control device based on the lifetime which is estimated.

With this configuration, it is possible to perform control suitable for the state of the temperature control device.

In addition, the load amount may include at least one of the number of times the special mode is turned on and an amount of operation of the temperature control device at a load equal to or higher than a predetermined standard limit threshold value.

With this configuration, the state of the temperature control device can be easily or appropriately managed.

The management controller may be further configured to store the load amount of the target in-vehicle device in the storage when the special mode is set, and the management controller may be configured to determine a compensation content of the vehicle based on the load amount of the target in-vehicle device.

With this configuration, the vehicle can be appropriately compensated.

According to the vehicle management system disclosed in this specification, when the special mode is set, the target in-vehicle device can be appropriately cooled.

### BRIEF DESCRIPTION OF DRAWINGS

Embodiment(s) of the present disclosure will be described based on the following figures, wherein:

FIG. 1 is a block diagram illustrating a configuration of a vehicle management system;

FIG. 2 is a diagram illustrating an example of a load amount of the temperature control device;

FIG. 3 is a diagram showing an example of a map for calculating a lifetime coefficient;

FIG. 4 is a diagram showing an example of a map for calculating a correction amount of a limit threshold value;

FIG. 5 is a diagram showing an example of a map for calculating a compensation ratio of a vehicle; and

FIG. 6 is a flowchart showing a control flow of the management controller.

### DESCRIPTION OF EMBODIMENT

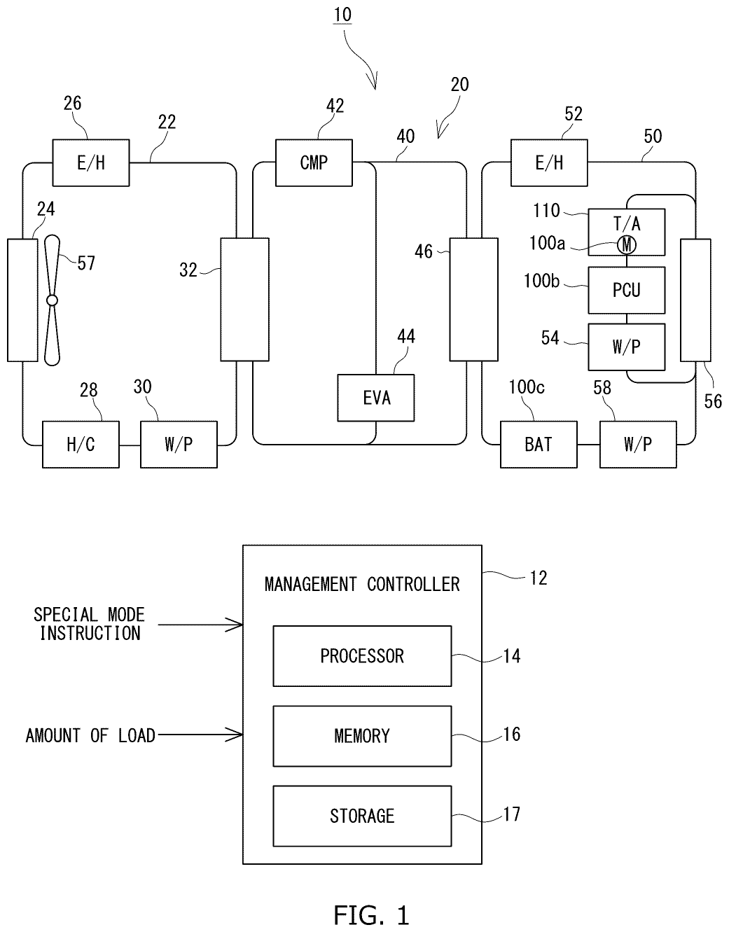

Hereinafter, a configuration of the vehicle management system 10 will be described with reference to the drawings. FIG. 1 is a block diagram illustrating a configuration of a vehicle management system 10. The vehicle management system 10 is mounted on a vehicle, and manages states of some in-vehicle devices (hereinafter, referred to as “target in-vehicle devices 100”) and the temperature control device 20. The type of the vehicle on which the vehicle management system 10 is mounted is not particularly limited. Therefore, the vehicle on which the vehicle management system 10 is mounted may be any of a battery electric vehicle, a hybrid electric vehicle, a fuel cell electric vehicle, and an engine vehicle. Hereinafter, a vehicle management system 10 mounted on a battery electric vehicle will be described as an example.

The vehicle management system 10 includes a temperature control device 20, a management controller 12, and a target in-vehicle device 100. The temperature control device 20 is a device that cools and controls a part of the target in-vehicle devices 100. Here, the target in-vehicle device 100 is an in-vehicle device managed by the vehicle management system 10, and is an in-vehicle device that contributes to traveling of the vehicle. The temperature control device 20 controls the temperature of a device that generates heat as the vehicle travels among the target in-vehicle devices 100. For example, the temperature control device 20 controls the temperature of the traveling motor 100a, the PCU 100b, and the battery 100c. Hereinafter, when the traveling motor 100a, the PCU 100b, and the battery 100c are not distinguished from each other, they are collectively referred to as a “target in-vehicle device 100”.

The traveling motor 100a is a motor generator that outputs traveling power and generates electric power by braking force. The traveling motor 100a is unitized with a transmission (not shown), and constitutes a transaxle 110. The battery 100c is a rechargeable secondary battery. Electric power is supplied from the battery 100c to the traveling motor 100a, and the electric power generated by the traveling motor 100a is charged to the battery 100c. The PCU 100b includes an inverter that drives the traveling motor 100a, a DC-DC converter that performs voltage conversion, and the like. The PCU 100b controls electric power supplied to the traveling motor 100a.

The temperature control device 20 cools and adjusts the temperature of the target in-vehicle device 100 as necessary. The temperature control device 20 includes a high-temperature cooling circuit 22, a refrigerant circuit 40, and a low-temperature cooling circuit 50. The high-temperature cooling circuit 22 circulates cooling water as a heat medium. The high-temperature cooling circuit 22 includes a heater core 28, an electric heater 26, a radiator 24, a water pump 30, and a radiator fan 57. The water pump 30 pumps and circulates the cooling water. The electric heater 26 heats the cooling water. The heated cooling water exchanges heat with the surrounding air in the heater core 28. By blowing the heated air into the vehicle, the vehicle interior is heated.

The radiator 24 air-cools the cooling water output from the heater core 28. The radiator 24 is arranged side by side with a radiator 56 of a low-temperature cooling circuit 50, which will be described later, in an up-down direction or a front-rear direction. The radiator fan 57 is disposed behind the radiators 24 and 56, and sucks the outside air so that the outside air flows toward the radiators 24 and 56.

The refrigerant circuit 40 circulates the refrigerant while changing its state. The refrigerant circuit 40 includes a compressor 42, an evaporator 44, and a water-cooled condenser 32. The compressor 42 compresses the refrigerant. The compressed refrigerant condenses in the water-cooled condenser 32. The condensed refrigerant is injected from an expansion valve (not shown) toward the evaporator 44 and expanded. At this time, the refrigerant is vaporized to cool the air around the evaporator 44. The air around the evaporator 44 is blown toward the inside of the vehicle, so that the inside of the vehicle is cooled. The water cooling condenser 32 discharges the heat of the cooling circuit to the cooling water of the high-temperature cooling circuit 22.

The low-temperature cooling circuit 50 circulates cooling water as a heat medium. The low-temperature cooling circuit 50 includes a chiller 46, an electric heater 52, a radiator 56, and water pumps 54 and 58. The low-temperature cooling circuit 50 adjusts the temperature of the target in-vehicle device 100, that is, the traveling motor 100a, the PCU 100b, and the battery 100c. The electric heater 52 heats the cooling water. The electric heater 52 is turned on when the target in-vehicle device 100 is heated. When cooling the target in-vehicle device 100, the cooling water absorbs heat of the target in-vehicle device 100. The heat of the cooling water is discharged to the outside air and the refrigerant circuit 40 via the radiator 56 and the chiller 46. The water pumps 54 and 58 pump and circulate the cooling water. Although not illustrated, the temperature control device 20 further includes a sensor that directly or indirectly detects the temperature of the target in-vehicle device 100, and the detected temperature of the target in-vehicle device 100 is transmitted to the management controller 12.

The management controller 12 manages the states of the temperature control device 20 and the target in-vehicle device 100. The management controller 12 controls driving of the temperature control device 20. The management controller 12 is physically a computer having a processor 14, a memory 16, and a storage 17. The storage 17 is a storage device for storing a history of a load amount, which will be described later. The storage 17 may be a storage device mounted in the vehicle or a cloud data area prepared on the Internet. In FIG. 1, the memory 16 and the storage 17 are shown separately, but both may be physically a single storage device.

In FIG. 1, the management controller 12 is illustrated as a single computer. However, the management controller 12 may be configured by combining a plurality of computers physically separated from each other. For example, the management controller 12 may be configured by combining an in-vehicle computer mounted on the vehicle and an external computer (for example, a server) disposed outside the vehicle. In this case, the in-vehicle computer and the external computer transmit and receive information to and from each other by communication. It should also be appreciated that all of the management controllers 12 may be mounted in the vehicle.

The management controller 12 controls operation of the temperature control device 20 based on the detected temperature of the target in-vehicle device 100. For example, the management controller 12 increases the output power of the compressor 42, the water pumps 30, 54, and 58, and the radiator fan 57 (accordingly, the load amount of the compressor 42 or the like) as the detected temperature of the target in-vehicle device 100 increases and the necessary cooling amount increases. As a result, the target in-vehicle device 100 is cooled more quickly. In addition, when a special mode described later is set, the management controller 12 changes the limit value of the control parameter (hereinafter, referred to as a “temperature control parameter”) of the temperature control device 20 so that the cooling capability of the target in-vehicle device 100 is improved as compared with a case where the special mode is not set.

Next, the special travelling and the special mode will be described. The special travelling is a traveling mode in which the traveling performance is more important than the fuel efficiency, the comfort, and the like. For example, course running in a circuit corresponds to “special travelling”. The special mode is a mode for performing this special travelling. The special mode can be selected for the vehicle on which the vehicle management system 10 is mounted. The vehicle may transition to the special mode in response to a user instruction. As another form, the vehicle may automatically transition to the special mode based on the current position of the vehicle, a communication result with an external communication device, and the like. For example, when the current position of the vehicle is in a circuit venue registered in advance, the mode may automatically transition to the special mode. When the vehicle receives the race program from the external communication device owned by the circuit operator, the vehicle may automatically transition to the special mode based on the race program.

When the special travelling is performed, the load amount on the target in-vehicle device 100 increases, and the heat generation amount of the target in-vehicle device 100 increases. Therefore, when the special mode is enabled, the management controller 12 changes the limit value of the temperature control parameter so that the cooling capability is improved as compared with the case where the special mode is disabled. The temperature control parameter is, for example, a limit threshold value of the output of the compressor 42 or the like, or a start or target temperature of cooling.

This will be specifically described. Normally, the management controller 12 suppresses the output limit threshold value of the compressor 42, the water pumps 30, 54, and 58, and the radiator fan 57 (hereinafter, collectively referred to as “electric equipment for temperature control”) to be equal to or less than a standard limit threshold value P1 defined in advance in consideration of fuel consumption, quietness, and the like. Specifically, the standard limit threshold value P1 is, for example, a power upper limit value or a rotation speed upper limit value of the electric equipment for temperature control.

Normally, when the detected temperature Td of the target in-vehicle device 100 is higher than the standard temperature control start temperature Ts1, the management controller 12 starts cooling the target in-vehicle device 100. This cooling is continued until the detected temperature Td becomes equal to or lower than the standard temperature control target temperature Tt1.

When the special mode is enabled, the management controller 12 changes the limit threshold value of the output of the electric equipment for temperature control to the special limit threshold value P2 higher than the standard limit threshold value P1. As a result, although the fuel consumption and noise are deteriorated, the cooling capability of the temperature control device 20 is improved, so that the target in-vehicle device 100 can be rapidly cooled. As a result, it is possible to prevent the temperature of the target in-vehicle device 100 from reaching the limit temperature even when the amount of heat generated by the target in-vehicle device 100 increases due to high-speed traveling.

When the special mode is set, the management controller 12 lowers the cooling start temperature and the cooling target temperature as compared with the case where the special mode is disabled. That is, when the special mode is set, the management controller 12 starts cooling when the detected temperature Td is higher than the special temperature control start temperature Ts2 (Ts2<Ts1), and ends cooling when the detected temperature Td reaches the special temperature control target temperature Tt2 (Tt2<Tt1). Accordingly, since the cooling of the target in-vehicle device 100 is performed early and for a long period of time, overheating of the target in-vehicle device 100 during high-speed traveling is prevented.

However, even if the limit value of the temperature control parameter is relaxed, when the special mode is set, the amount of load on the temperature control device 20 and the target in-vehicle device 100 increases as compared with the case where the special mode is not set. For example, when the output limit threshold value of the compressor 42 is changed from the standard limit threshold value P1 to the special limit threshold value P2, the load amount of the compressor 42 increases, and the lifetime of the compressor 42 decreases. In addition, when the special mode is set, the restriction on the traveling motor 100a is also relaxed, and the lifetime of the traveling motor 100a decreases with the relaxation of the restriction.

The management controller 12 manages the states (particularly, lifetimes) of the temperature control device 20 and the target in-vehicle device 100. Specifically, when the special mode is set, the management controller 12 monitors the amount of load acting on the electric equipment for temperature control (Compressor 42, radiator fan 57, and water pumps 30, 54, and 58) and records the amount of load in the storage 17.

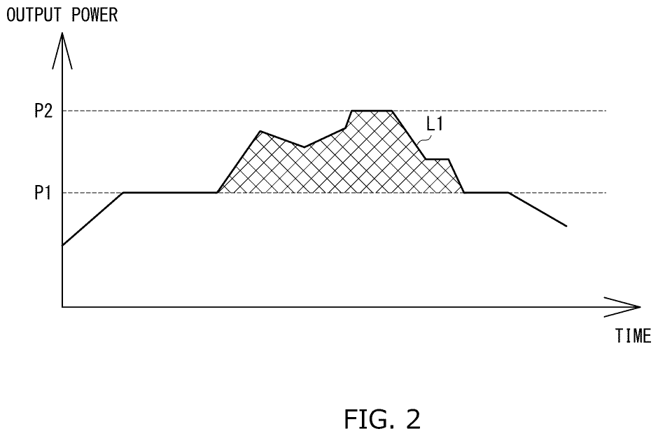

Here, the load amount of the electric equipment for temperature control is particularly large when the electric equipment for temperature control is operating beyond the standard limit threshold value P1. Therefore, the load amount of the electric equipment for temperature control may be, for example, an integrated time during which the electric equipment for temperature control operates beyond the standard limit threshold value P1. Further, as another form, the load amount may be an integrated value of the operation time of the electric equipment for temperature control and the output excess amount from the standard limit threshold value P1. That is, in FIG. 2, when the solid line L1 indicates the output change of the electric equipment for temperature control, the area of the cross-hatched portion in FIG. 2 may be used as the load amount of the electric equipment for temperature control. Further, the load amount may be the number of times of integration in which the special mode is set.

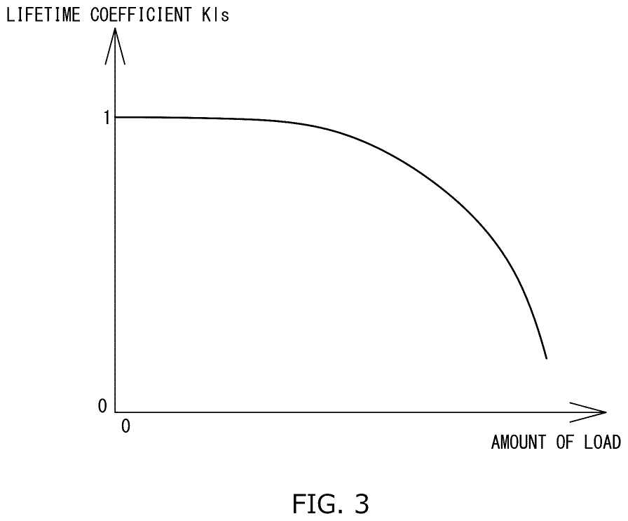

The management controller 12 estimates the lifetime of the electric equipment for temperature control based on the load amount of the electric equipment for temperature control stored in the storage 17. In general, the lifetime of the electric device is estimated from the integrated operating time. The management controller 12 may calculate the standard lifetime LSs from the integrated operation time and correct the standard lifetime LSs according to the load amount stored in the storage 17. For example, the management controller 12 may calculate the lifetime coefficient Kls (0<Kls≤1) which becomes smaller as the load amount becomes larger based on the map shown in FIG. 3. Then, the management controller 12 may calculate the integrated value of the standard lifetime LSs and the lifetime coefficient Kls as the estimated lifetime LS* of the electric equipment for temperature control. That is, LS*=LSs×Kls may be set. The above-described method of calculating the estimated lifetime LS* is an example, and may be appropriately changed.

The management controller 12 may change the management content of the electric equipment for temperature control based on the calculated estimated lifetime LS*. For example, if the estimated lifetime LS* falls below a defined threshold, the user may be alerted. Alternatively, the management controller 12 may change the temperature control parameter according to the estimated lifetime LS*. For example, the lower the estimated lifetime LS* is, the lower the limit threshold value of the electric equipment for temperature control may be set.

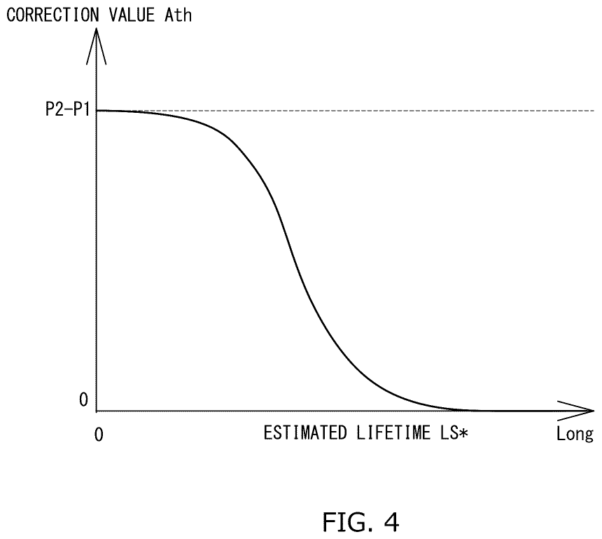

For example, the management controller 12 may calculate a correction value Ath (0≤Kth<(P2-P1)) that becomes smaller as the estimated lifetime LS* becomes lower based on the map shown in FIG. 4. When the special mode is set, the management controller 12 may set a value obtained by subtracting the correction value Ath from the special limit threshold value P2 (i.e., P2-Ath) as the restriction threshold value of the electric equipment for temperature control. Of course, such a method of calculating the limit threshold value is merely an example, and may be appropriately changed. In addition to the limit threshold value, the temperature control start temperature or the temperature control target temperature may be changed. In this case, the lower the estimated lifetime LS* is, the higher the temperature control start temperature and the temperature control target temperature may be. As another form, when the estimated lifetime LS* is equal to or less than a prescribed reference value, the setting of the special mode may be prohibited. In any case, by changing the control parameter of the electric equipment for temperature control in accordance with the estimated lifetime LS*, it is possible to suppress a failure of the electric equipment for temperature control.

In addition, the management controller 12 may store not only the load amount of the temperature control device 20 but also the load amount of the target in-vehicle device 100 in the storage 17. The load amount of the target in-vehicle device 100 may be, for example, the number of times the temperature of the target in-vehicle device 100 exceeds a predetermined reference value or the integrated time. The load amount of the target in-vehicle device 100 may be the number of times the special mode is set, a change history of a control parameter of the target in-vehicle device 100 (for example, the number of rotations of the traveling motor 110a), or the like.

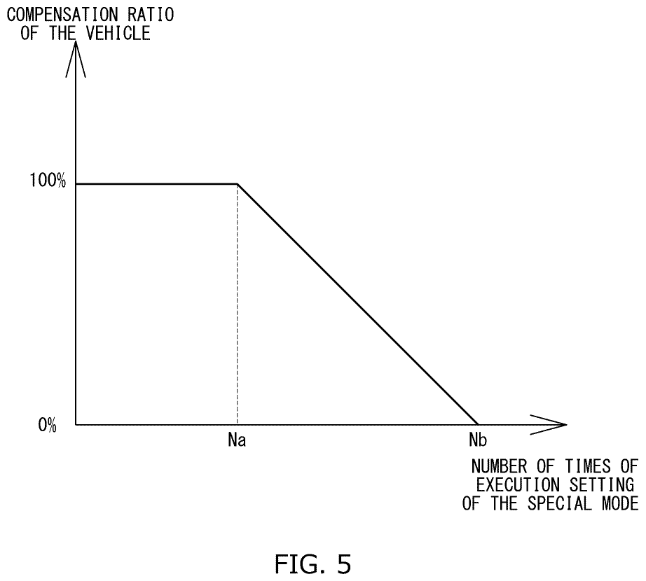

The management controller 12 may change at least one of the compensation content and the evaluation amount of the vehicle based on the load amount of the target in-vehicle device 100 stored in the storage 17. For example, the management controller may change the compensation ratio of the vehicle based on the map illustrated in FIG. 5. In the example of FIG. 5, as the number of times of execution setting of the special mode increases, the compensation ratio of the vehicle decreases. In addition, the management controller 12 may estimate the lifetime of the target in-vehicle device 100 or the vehicle based on the load amount of the target in-vehicle device 100. Then, the management controller 12 may decrease the evaluation amount of the vehicle, the compensation amount when the vehicle fails, or both, as the estimated lifetime is lower.

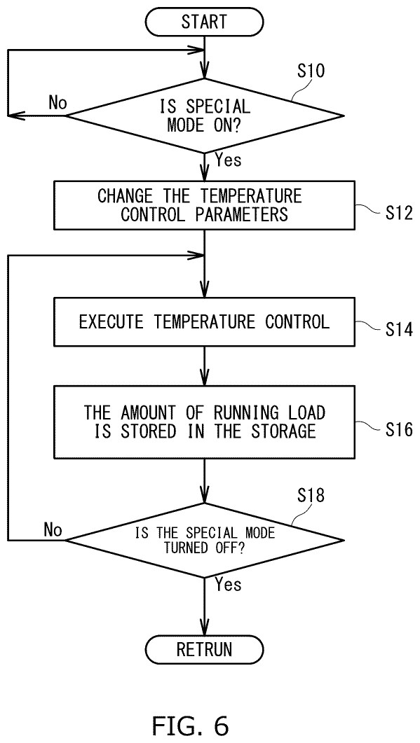

FIG. 6 is a flowchart showing the flow of processing by the management controller 12. As shown in FIG. 6, the management controller 12 waits until the special mode is turned on. When the special mode is turned on (Yes in S10), the management controller 12 changes the temperature control parameter value to a value for the special mode (S12). At this time, the value of the temperature control parameter may be corrected according to the load amount stored in the storage 17 (S18).

Subsequently, the management controller 12 drives the electric equipment for temperature control based on the temperature control parameter for the special mode, and executes the temperature control process (S14). During that time, the load amounts of the electric equipment for temperature control and the target in-vehicle device 100 are stored in the storage 17 (S16). The above process is repeated until the special mode is turned off.

As described above, when the special mode is set, the target in-vehicle device 100 can be protected more appropriately by changing the temperature control parameter so as to improve the cooling capability. When the special mode is set, the load amounts of the temperature control device 20 and the target in-vehicle device 100 are stored in the storage 17, so that the temperature control device 20 and the target in-vehicle device 100 can be managed more appropriately.

Note that the configuration described so far is one example, and other configurations may be changed as long as the configuration described in claim 1 is provided. For example, in the above description, the vehicle management system 10 mounted on the battery electric vehicle has been described as an example. However, the technology disclosed in the present specification may be mounted on other types of vehicles without being limited to battery electric vehicles. Therefore, the vehicle management system 10 may be installed in an engine vehicle, a hybrid electric vehicle, or the like. In this case, the temperature control device 20 includes a cooling circuit that cools the engine, and the temperature control electric device includes a water pump that circulates engine cooling water.

### REFERENCE SIGNS LIST

10 vehicle management system, 12 management controller, 14 processor, 16 memory, 17 storage, 22 high-temperature cooling circuit, 24 radiator, 26 electric heater, 28 heater core, 30 water pump, 32 water cooling condenser, 40 refrigerant circuit, 42 compressor, 44 evaporator, 46 chiller, 50 low-temperature cooling circuit, 52 electric heater, 54 water pumps, 56 radiator, 57 radiator fan, 100 target in-vehicle device, 100a traveling motor, 100b PCU, 100c battery, 110 transaxle.

1. A vehicle management system comprising:
a temperature control device configured to cool and control the temperature of a target in-vehicle device that generates heat as a vehicle travels; and
a management controller that controls driving of the temperature control device,
wherein the management controller is configured to change a limit threshold value of a control parameter of the temperature control device in a manner to increase a cooling capability when a special mode, in which a travel performance is prioritized over a fuel consumption, is set as compared with a case where the special mode is not set.

2. The vehicle management system according to claim 1, wherein
the management controller includes a storage provided inside or outside the vehicle, and
the management controller is configured to store a load amount of the temperature control device in the storage when the special mode is set.

3. The vehicle management system according to claim 2, wherein
the management controller is configured to:
estimate a lifetime of the temperature control device based on the load amount stored in the storage; and
correct the limit threshold value of the control parameter of the temperature control device based on the lifetime which is estimated.

4. The vehicle management system according to claim 3, wherein
the load amount includes at least one of the number of times the special mode is turned on and an amount of operation of the temperature control device at a load equal to or higher than a predetermined standard limit threshold value.

5. The vehicle management system according to claim 2, wherein
the management controller is further configured to store the load amount of the target in-vehicle device in the storage when the special mode is set, and
the management controller is configured to determine a compensation content of the vehicle based on the load amount of the target in-vehicle device.
